(19) United States
(12) Patent Application Publication
(10) Pub. No.: US 2002/0175291 A1
(43) Pub. Date: Nov. 28, 2002

(54) Radiation detection and discrimination device, radiation survey instrument, and method

(76) Inventors: Paul L. Reeder, Richland, WA (US); Sonya M. Bowyer, Richland, WA (US)

Correspondence Address: WELLS ST. JOHN ROBERTS GREGORY & MATKIN P.S., 601 W. FIRST AVENUE, SUITE 1300, SPOKANE, WA, 99201-3828, US

(21) Appl. No.: 09/828,316

(22) Filed: Apr. 6, 2001

(51) Int. Cl. G01T 1/20

(52) U.S. Cl. 250/369

(57) ABSTRACT

A radiation detection and discrimination device includes a radiation sensor and signal processing circuitry. The radiation sensor includes a LiBaF₃ scintillator configured to simultaneously detect presence of a first type of radiation and a second type of radiation. The radiation sensor generates an output signal for each type of detected radiation. The signal processing circuitry communicates with the sensor, and includes data analysis circuitry and memory. The signal processing circuitry is operative to receive at least one output signal from the sensor. The memory is operative to store at least one predetermined indicia characterizing membership of an output signal within a group comprising a unique type of radiation. The data analysis circuitry compares the output signal with the at least one predetermined indicia to determine membership of the output signal within one group of a plurality of unique groups. Each group comprises a unique type of radiation including the first type of radiation and the second type of radiation. A method is also provided.

### PATENT RIGHTS

This invention was made with Government support under Contract DE-AC0676RLO1830 awarded by the U.S. Department of Energy. The Government has certain rights in the invention.

### TECHNICAL FIELD

the invention pertains to the detection, discrimination, and quantization of radiation. More particularly, this invention relates to an apparatus and method for simultaneously detecting and separately measuring quantities of various types of radiation, such as alpha, beta/gamma-ray, thermal neutron, and fast neutron radiation, using a single, common instrument.

### BACKGROUND OF THE INVENTION

Radiation detection is required in a number of industrial applications. One application entails surveying an individual's clothing when leaving a contamination zone within a nuclear contamination environment. Another application entails monitoring radiation levels at nuclear reactors or accelerator facilities. Even other applications entail monitoring radiation doses for nuclear medicine, identifying nuclear material for safeguards or non-proliferation purposes, and conducting radiation measurements for basic research in nuclear science.

However, radiation detection instruments typically require the use of different instruments when measuring different types of radiation. These different instruments use different sensor technologies. For example, thermal neutrons are usually detected in ³He or BF₃ gas-filled proportional counters. Additionally, fast neutrons are often detected using the same type of proportional counters, but surrounded by polyethylene moderator material. Alternatively, fast neutrons can be detected using liquid scintillators or proton-recoil detectors.

When conducting radiation contamination surveys, two or more instruments are usually required which require the use of two different sensor technologies. For example, alpha radiation is normally detected using a thin window ion chamber which consists of a gas filled volume with an internal electrode to measure ion current produced in the gas by ionization. However, the window needs to be relatively thin in order to allow alpha particles to penetrate into the gas volume. Another instrument is needed to measure beta and gamma-ray radiation. More particularly, beta and gamma-ray radiation are typically measured together using a Geiger-Muller tube comprising a gas-filled tube with a central anode wire which collects electrons from multiple cascades, or avalanches, initiated by ionization of the gas by the incident radiation.

For the case of radiation contamination surveys, two different instruments are used to survey an individual's clothing as they leave a contamination zone. Even though each of these instruments can be made portable using electronics, batteries, and sensors provided in a hand-held box, two separate instruments are required. Alternative configurations entail attaching a sensor to a box by a cable that allows the sensor to be moved around during use. However, two distinct instruments are still required.

Accordingly, prior art techniques entail using two separate instruments to perform two separate body scans: one with an alpha survey instrument and another with a beta/gamma-ray survey instrument. Improvements are therefore needed in order to reduce the complexity, cost, and size of instruments. Many applications would benefit from the availability of a single sensor usable to record different types of radiation in a single instrument which would reduce cost, weight, and complexity of having to use two or more instruments. Furthermore, the time needed to conduct a contamination survey would be cut in half by providing a single instrument capable of distinguishing multiple types of radiation, such as alpha and beta/gamma-ray radiation in a single scan. This would save a tremendous amount of time when scanning thousands of radiation workers in nuclear laboratory facilities, clean-up operations, and laboratory environments.

### SUMMARY OF THE INVENTION

A radiation detection and discrimination device enables the measurement of neutron count rates and energy spectra simultaneously while measuring gamma-ray count rates and energy spectra using a single detector. According to another embodiment, a single instrument and technique is provided to measure quantities of thermal neutron, fast neutron, and beta/gamma-ray radiation separately using a single scintillation material. The instrumentation can be configured for rugged and portable use in the form of a survey instrument. Optionally, the instrument can be configured with a fixed installation in the form of a portal monitor. In either case, the instrument can be used in the course of conducting nuclear research. Furthermore, the instrument can replace two separate instruments that are currently used to serve two different types of radiation contamination, such as when serving for alpha as well as beta/gamma-ray contamination.

According to one aspect, a radiation detection and discrimination device includes a radiation sensor and signal processing circuitry. The radiation sensor includes a LiBaF₃ scintillator configured to simultaneously detect presence of a first type of radiation and a second type of radiation. The radiation sensor generates an output signal for each type of detected radiation. The signal processing circuitry communicates with the sensor, and includes data analysis circuitry and memory. The signal processing circuitry is operative to receive at least one output signal from the sensor. The memory is operative to store at least one predetermined indicia characterizing membership of an output signal within a group comprising a unique type of radiation. The data analysis circuitry compares the output signal with the at least one predetermined indicia to determine membership of the output signal within one group of a plurality of unique groups. Each group comprises a unique type of radiation including the first type of radiation and the second type of radiation.

According to another aspect, a radiation survey instrument includes a scintillation sensor and signal processing circuitry. The scintillation sensor includes a single material capable of simultaneously detecting and discriminating a plurality of unique types of radiation. The scintillation sensor generates an output signal from a detected type of radiation. The signal processing circuitry communicates with the sensor. The signal processing circuitry is operative to receive the generated output signal from the scintillation sensor, and compare the output signal with a predetermined histogram of pulse amplitude versus time. The signal processing circuitry compares the pulse shape of the output signal with the histogram in order to determine membership of the output signal within an identified type of radiation from the plurality of unique types of radiation.

According to yet another aspect, a method is provided for simultaneously measuring the presence of at least two unique types of radiation. The method includes: in a radiation detector, detecting the presence of one type of at least two types of radiation; in response to detecting the one type of radiation, producing an output signal having a pulse shape comprising output pulse amplitude versus time; storing a first digital data set representative of a first type of radiation and a second digital data set representative of a second type of radiation; and comparing the output signal pulse shape of the one type of detected radiation with the first digital data set and the second digital data set to determine identification of the output signal pulse shape as either a first type of radiation or a second type of radiation.

### BRIEF DESCRIPTION OF THE DRAWINGS

Preferred embodiments of the invention are described below with reference to the following accompanying drawings.

FIG. 1 is a simplified schematic diagram illustrating a radiation detector and discrimination device according to one aspect of the present invention.

FIG. 2 is a graph illustrating a two-dimensional histogram of short- interval pulse heights versus long-interval pulse heights for a 137CS source with no moderator near the scintillator.

FIG. 3 is a one-dimensional histogram of total-interval pulse heights for events falling into the left region “A” of FIG. 1.

FIG. 4 is a two-dimensional histogram of short-interval pulse heights versus long-interval pulse heights for a PuBe source with polyethylene moderator near the scintillator.

FIG. 5 is a one-dimensional histogram of total-interval pulse heights for events failing into the lower-right region “B” of FIG. 4.

FIG. 6 is a two-dimensional histogram of short-interval pulse heights versus long-interval pulse heights for a long background count with no polyethylene moderator near the LiBaF₃scintillator F.

FIG. 7 is a one-dimensional histogram of total-interval pulse heights for events falling in the lower right region “B” defined in FIG. 6.

### DETAILED DESCRIPTION OF THE PREFERRED EMBODIMENTS

This disclosure of the invention is submitted in furtherance of the constitutional purposes of the U.S. Patent Laws “to promote the progress of science and useful arts” (Article 1, Section 8).

Reference will now be made to a preferred embodiment of Applicant's invention. An exemplary implementation is described below and depicted with reference to the drawings comprising an analysis device in the form of a radiation detector and discrimination device, shown in two distinct applications. While the invention is described by way of a preferred embodiment, it is understood that the description is not intended to limit the invention to such embodiment, but is intended to cover alternatives, equivalents, and modifications which may be broader than the embodiment, but which are included within the scope of the appended claims.

In an effort to prevent obscuring the invention at hand, only details germane to implementing the invention will be described in great detail, with presently understood peripheral details being incorporated by reference, as needed, as being presently understood in the art.

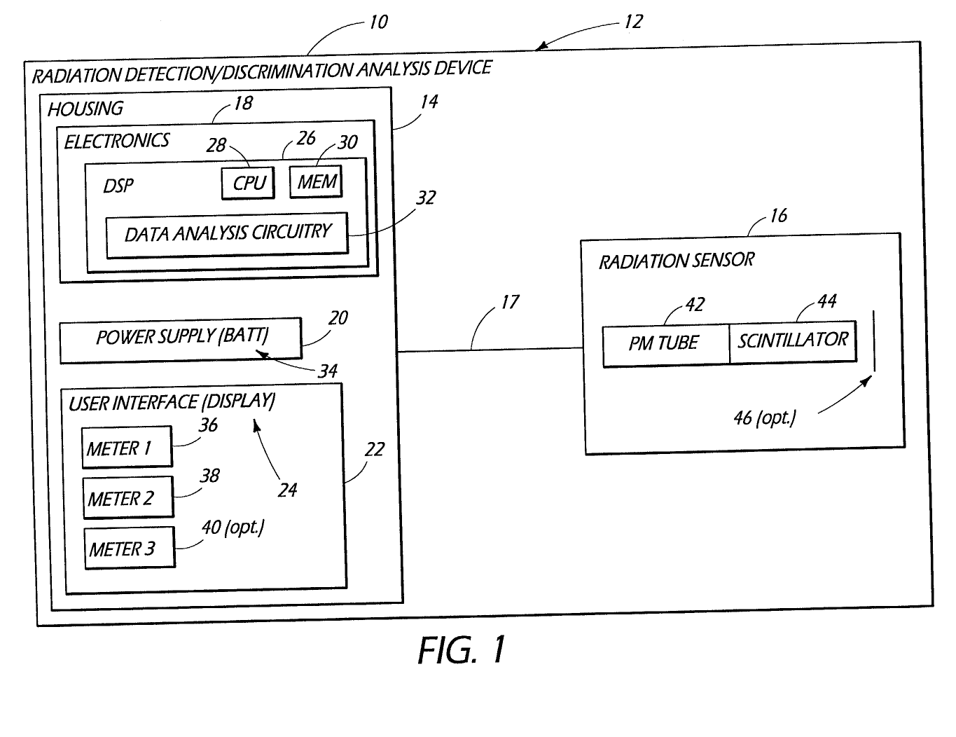

A radiation detection/discrimination analysis device is described below with reference to FIG. 1 and identified by reference numeral 10. Device 10 in one form comprises a radiation survey instrument 12. Instrument 12 includes an instrumentation housing 14 and a radiation sensor 16 remotely coupled with housing 14 via a flexible electrical cable 17. Cable 17 comprises a flexible electrical cable that enables a user to manipulate placement of sensor 16 when detecting and/or discriminating radiation such that sensor 16 can be independently moved relative to housing 14, while still enabling portable transferof housing 14 (and associated components) during transfer of device 10 between locations. Accordingly, cable 17 enables sensor 16 to be used as a survey instrument 12.

Housing 14 comprises an electronics package assembly constructed from metal or plastic and used to house electronics 18, a power supply 20, and a user interface 22. Electronics 18 comprises a digital signal processor (DSP) 26. DSP 26 includes a central processing unit (CPU) 28, memory 30, and data analysis circuitry 32. According to one implementation, data analysis circuitry 32 is implemented within CPU 28.

According to one implementation, power supply 20 comprises a battery 34. Alternatively, power supply 20 can comprise an electrical system configured to convert AC current from a wall outlet into DC current as required by analysis device 10.

As shown in FIG. 1, user interface 22 comprises a display 24 viewable by a user. More particularly, display 24 comprises a plurality of discretely viewable meters 36, 38 and 40, depicted as “Meter 1”, “Meter 2”, and “Meter 3”, respectively. Meter 3 (#40) is optional, and is provided in an alternative, second construction described below. A “meter” is understood to refer to an instrument or device for measuring, recording and viewing a quantity of unique radiation. Accordingly, meters 36, 38, and 40 are each dedicated to displaying a value indicating a quantity of detected radiation that is unique to that specific meter. Optionally, user interface 22 can display acknowledgment information reading detected types of radiation, thereby omitting individual meters 36, 38 and 40. For example, a “Pass” or “Fail” condition can be displayed on a graphical user interface (GUI) indicating absence or presence, respectively, of a detected type of radiation.

For example, meter 36 can be configured in one embodiment to display detected quantities of alpha radiation, while meter 38 can be configured to display detected quantities of beta/gamma-ray radiation. According to another embodiment, meter 36 is configured to display detected quantities of thermal neutron radiation, meter 38 is configured to display detected quantities of fast neutron radiation, and meter 40 is configured to display detected quantities of beta/gamma-ray radiation.

Radiation sensor 16 comprises a photomultiplier (PM) tube 42 and a scintillator 44. According to an alternative or optional implementation, radiation sensor 16 also comprises a thin, light-tight window 46.

According to a first construction, radiation detection/discrimination analysis device 10 includes sensor 16 comprising a scintillation sensor that is based on an inorganic crystal LiBaF₃ doped with Ce (as well as with other elements, as discussed below). The provision of such a scintillator 44 within sensor 16 has been demonstrated to give very different pulse shapes at meters 36 and 38, depending on whether the incident radiation is beta radiation or gamma-ray radiation, or whether the radiation comprises heavy charged particles such as protons, deuterons, tritons, or alpha particles.

One suitable scintillator 44 based on an inorganic crystal LiBaF₃ doped with Ce and other elements has been developed by researchers at Delft University of Technology (hereinafter referred to as the Delft group), as well as by others. Details of such a scintillator 44 are disclosed in M. J. KNITEL, P. DORENBOS, J. T. M. de HAAS, C. W. E. van EIJK, Nucl. Instr. Meth. Phys. Res. A 374 ( 1996 ) 197; C.M. COMBES, P. DORENBOS, C. W. E. van EIJK, J. Y. GESLAND, P. A. RODNYI, J. Luminescence 72-74 (1997) 753; C. M. COMBES, P. DORENBOS, R. W. HOLLANDER, C. W. E. van EIJK, Nucl. Instr. Meth. Phys. Res. A; A. GEKTIN, N. SHIRAN, A VOLOSHINOVSKI, V. VORONOVA, G. ZIMMERER, IEEE Trans. Nucl. Sci. 45 (1988) 505, each herein incorporated by reference.

Differences in pulse shape can be determined to clearly distinguish different types of radiation. For example, neutrons are detected by neutron capture in a ⁶Li isotope which breaks up into an alpha particle and a triton particle. A resulting pulse has a very different shape that is distinguishable from a pulse that is induced by gamma-ray radiation.

In order to experimentally verify performance, several crystals of LiBaF₃, both doped with Ce and undoped, were studied to verify the ability of such material to discriminate different types of radiation. As a result, it was determined that such material, when used in the apparatus of FIG. 1, was able to discriminate neutron particles from gamma-ray radiation.

Using DSP 26 and data analysis circuitry 32, as described below, a pulse shape analysis technique is used to distinguish between two unique types of radiation. The pulse shape analysis technique uses the amplitude of a pulse integrated over a short time interval versus the amplitude of the pulse integrated over a long time interval in order to discriminate two types of radiation.

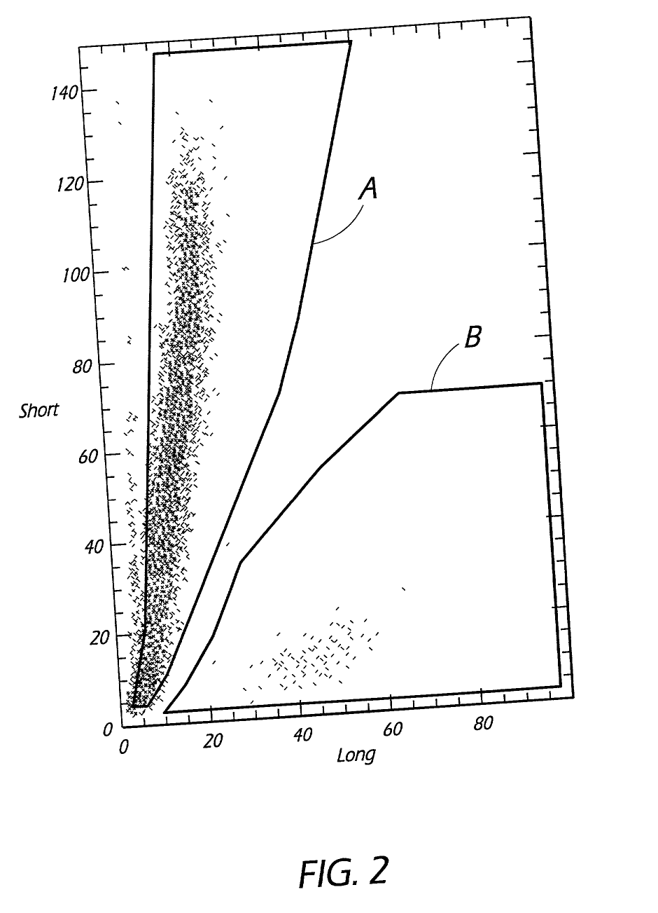

As described below in further detail by example with reference to FIGS. 2, 4 and 6, two-dimension histograms of “short” pulse heights versus “long” pulse heights illustrate gamma-ray radiation and neutron radiation appearing in very different regions A and B, respectively, of the respective histograms. Additionally, there is a distinctive distribution corresponding to elastic scattering of fast neutrons on Li atoms in the inorganic crystal. Because elastic scattering cross sections are greater than neutron capture reactions for fast neutrons, elastic scattering provides a more sensitive technique for detecting the presence of fast neutrons. In an alternative construction, this technique can be further exploited if the crystal is made using highly enriched ⁶Li. In this case, fast neutron capture events appear in the same region of the histogram as the thermal neutrons, but at pulse heights larger than those for thermal neutron events.

According to a first implementation, radiation detection/discrimination analysis device 10 uses a LiBaF₃ scintillator 44 in combination with a pulse shape analysis technique in order to distinguish alpha radiation from beta/gamma-ray radiation. In such case, the scintillation material has a thin, light-tight window 46 in order to allow alpha particles to reach the scintillator. It has been demonstrated that the characteristics of the alpha induced pulse are almost identical to the characteristics of the neutron induced pulse. In the absence of a moderator, the number of thermal neutrons detected will be minimal. In order to further distinguish alpha particles from thermal neutron particles, a window of suitable thickness can be added in order to degrade the pulse amplitude for the alpha particles so that a pulse height peak due to alpha particles can be distinguished from the pulse height peak due to neutron particles.

According to a second implementation, radiation detection/discrimination device 10 uses a LiBaF₃ scintillator 44 in combination with a pulse shape analysis technique in order to distinguish thermal neutron, fast neutron, and beta/gamma-ray radiation. The scintillator material is mounted on a quartz window photomultiplier (PM) tube. Pulse shape analysis electronics, as described below, will determine whether each event is due to a thermal neutron, fast neutron, or beta/gamma-ray event.

Accordingly, radiation survey instrument 12 combines the capabilities of two radiation survey instruments into a single instrument. According to the first implementation, a count rate for alpha radiation is displayed on a first meter 36 and a count rate for beta/gamma-ray radiation is displayed on a second meter 38. Electronics 18 for the resulting two channels of data are preferably miniaturized in order to fit into a handheld box, or housing 14. A single radiation sensor 16 is then used to survey regions of interest, such as clothing, tools, and/or bench-tops in work areas in order to independently and simultaneously measure two different types of radiation.

According to one construction, sensor 16 is constructed from solid material having no mechanical action, thereby rendering sensor 16 relatively rugged and compact. Additionally, sensor 16 is relatively insensitive to temperature and pressure changes. The resulting efficiency at detecting gamma-ray radiation will be much higher than that for a Geiger-Muller tube because of the density of the solid material. The efficiency for alpha detection will be about 100% for each alpha particle which enters the detector volume. If desired, a third channel of data can be displayed, corresponding to the thermal neutron count, as is implemented according to the alternative implementation of device 10 depicted in FIG. 1.

For the alternative implementation of device 10, the count rate for thermal neutron radiation is shown on one meter 36, the count rate for fast neutrons is shown on a second meter 38, and the count rate for beta/gamma-ray radiation is shown on a third meter 40. Electronics 18 are similarly miniaturized in order to fit into a handheld box or housing 14. As an alternative configuration, larger area crystals can be mounted in a portal monitor configuration.

In the alternative implementation for device 10 of FIG. 1, three types of radiation can be identified and reported separately, using a single sensor 16. However, electronics 18 are configured with slightly greater complexity in order to allow for measurement of fast neutron pulse height spectra which are directly related to the energy spectrum of the fast neutrons. Such configuration is of direct benefit in identifying special nuclear materials compared to radioactive (alpha, n) sources.

Use of electronics 18 does not depend on prior irradiation of the crystals to permit neutron activation of the Ce+³ luminescence. As a result preparation of the crystals is simplified, and greater discrimination is provided between neutrons and gamma rays than by prior art techniques.

### Experimental Verification of Neutron/Gamma-Ray Discrimination Techniques Using a LIBaF₃ Scintillator

As previously discussed, the detection of neutrons in the presence of significant gamma-ray radiation is often required in arms control, material accountability, and nuclear smuggling scenarios. Furthermore, such detection is also required in basic nuclear research. The use of a new scintillator material, LiBaF₃, offers the possibility of measuring neutron count rates and energy spectra simultaneously while measuring gamma-ray count rates and energy spectra, and while using a single detector. These capabilities are enable because LiBaF₃ exhibits a very fast core-valence luminescence under gamma-ray irradiation, whereas this component is missing under neutron irradiation. Relatively simple pulse shape analysis techniques can be used to obtain excellent neutron/gamma-ray discrimination. Following are experimental laboratory results illustrating these capabilities.

The scintillation properties of LiBaF₃ have been previously reported. This inorganic material is remarkable because of the presence of both core valence luminescence (CV) and self-trapped-exciton luminescence (STE) under gamma-ray irradiation, whereas only the STE luminescence is present under neutron or alpha irradiation. Based upon development of Applicant's device of FIG. 1, the dramatic difference between the luminescence under gamma-ray or neutron irradiation permits extremely good differentiation between these two types of radiation using relatively simple pulse shape discrimination techniques.

According to Knitel, et al. (see Thesis by M. J. Knitel, T. U. Delft 1998; Thesis by C. Combes, T. U. Delft 1999, previously incorporated by reference), gamma-ray irradiation produces CV photons with a lifetime of 0.8 ns and a yield of 1200 photons per MeV of excitation, whereas neutron irradiation produces less than 10 CV photons per neutron capture. The STE luminescence is produced with a 6 μs lifetime and gives 1600 photons per MeV for gamma-ray irradiations and 3500 photons per capture for neutron irradiation. The CV photons are emitted in a narrow band around 187 nm, whereas the STE photons are emitted in a broader band around 300 nm.

Because of the high energy of the CV photons, the luminescence from LiBaF₃ needs to be detected by a quartz window photomultiplier tube.

Recognizing that the 6 μs lifetime is rather long for nuclear counting purposes, previous efforts by the Delft group have studied several LiBaF₃ crystals doped with Ce⁺³. It was hoped that the STE excitation energy would be transferred to the Ce⁺³ ions and be emitted with the characteristic Ce⁺³ lifetime of about 50 ns. Because it is difficult to get Ce⁺³ into the LiBaF₃ crystal lattice, other dopants such as K⁺ or Rb⁺ were added to enhance the concentration of Ce⁺³. The Ce⁺³ doped crystals had an additional luminescence component of about 35 to 50 ns indicating that some of the excitation energy from gamma-ray irradiations was being emitted from the Ce⁺³. Prior research by the Delft group has used standard nuclear counting electronics to demonstrate that very clean separation of neutron pulses from gamma-ray pulses can be achieved.

Because of a present interest in detecting neutrons in the presence of large fluxes of gamma rays for applications in arms control, material accountability, and nuclear smuggling, Applicant began investigations of LiBaF₃ and other Li containing scintillators. It is expected that significant improvements can be achieved in the following areas.

1. Larger crystals;

2. Improved doping to shorten the STE lifetime;

3. Greater light output in both the fast and slow components;

4. Crystals enriched in ⁶Li to improve neutron detection efficiency;

5. Improved data acquisition systems for gamma-ray, alpha, and neutron spectroscopy.

In the following, first results are discussed from studies of LiBaF₃ compositions, lifetime measurements, light output, and neutron/gamma-ray discrimination.

### Composition of Test Samples

Undoped samples of LiBaF₃ and samples doped with Ce alone or Ce and Rb were obtained from a commercial crystal grower. In addition, a sample of Ce and Rb doped LiBaF₃ was provided, as well as Ce and K doped crystals. The source and sizes of these samples are given in Table 1. Besides the large variations and irregularities in the crystal shapes, the number of polished surfaces also varied.

The concentration of the dopants in the melt were each 1 mol % for the crystals from AC Materials, of Winter Park, Fla., and 2% for the crystals from Delft, but the actual concentrations in the crystals were much less. Because the Ce⁺³ has a strong influence on the fluorescence lifetimes and abundances, it was necessary to determine the actual Ce content of each sample. This was done by laser ablation inductively coupled plasma mass spectrometry (ICP/MS). The results of the composition measurements are given in Table 2. The compositions are based on laser ablation while rastering the laser beam over a small area. For the samples doped with Ce and Rb, it was noted that the Rb abundance in the crystal is about half the Rb abundance in the melt. It was noted that very little Ce got into the crystal—the abundance in the crystal being about 200 times less than the abundance in the melt. Although the Ce concentration is small in all crystals, there are dramatic differences in the scintillation output, as discussed below. Thus there is an opportunity to improve understanding by conducting more detailed studies of the light output as a function of the crystal composition.

There appears to be a factor of about 45 difference in the Ce concentration measured by the Delft group (shown in Table 3) and the concentrations measured by Applicant. The concentrations measured by the Delft group were based on optical absorption coefficient measurements compared to a standard calibrated by mass spectrometry. The large discrepancy between these Delft measurements and those measurements made by Applicant is not fully understood at this time.

### Fluorescence Light Output

Measurements of the fluorescence yields and lifetimes are currently in progress by Applicant for the samples obtained from AC Materials. Previous measurements at Delft University by C. M. Combes are briefly summarized in Table 3. The sample with Ce+K doping is the same as our sample E, and the sample with Ce+Rb doping is the same as our sample D in Tables 1 and 2. All four of the samples in Table 3 showed the core valence luminescence (CV) with a lifetime of less than 1 ns. When Ce⁺³ is present, a component with a lifetime of 10's of ns is present which is characteristic of Ce⁺³ luminescence.

In the Delft lifetime measurements of Rb+Ce doped crystals, the 34 ns component due to Ce⁺³ fluorescence was not present under neutron irradiation unless the crystal had been subjected to intense irradiation with a ⁶⁰Co source causing coloration of the entire crystal. The electronic discrimination techniques developed at Delft are based on the presence or absence of the ^{˜}1 ns CV fluorescence relative to the ^{˜}35 ns STE fluorescence from Ce⁺³. These techniques are thus dependent on prior irradiation of the doped crystals. In contrast, Applicant has developed a neutron/gamma-ray discrimination technique based on the presence or absence of the CV and the ^{˜}35 ns Ce⁺³ fluorescence relative to the ^{˜}2.2 μs STE fluorescence using unirradiated crystals.

### Data Acquisition System

Applicant's data acquisition system for performing an experimental verification of the discrimination techniques for the device of FIG. 1 consists of a multi-input Charge-to-Digital Converter (QDC) interfaced to a multiple-parameter data acquisition computer. Such data acquisition system was used to generate the histograms of FIGS. 2, 4 and 6. The signal from the photomultiplier tube (Philips XP2020Q) is sent to three separate inputs to the QDC. Each input is gated separately to record the amount of charge in various portions of the pulse. A “short” gate of 60 ns starting 20 ns before the pulse records the fast component of the scintillation light due to the Ce⁺³ fluorescence. A “long” gate of about 1.35 μs records the long component of the scintillation light due to self-trapped excitons (STE). The combined short and long components are recorded by a “total” gate of about 1.4 μs. The Master gate for the QDC is 1.6 μs to encompass all other gates. However, the master gate is subject to a veto pulse of 11.5 μs generated by a gate and delay generator which prevents re-triggering until the signal drops below the discriminator threshold.

A two-dimensional array of the “short” signal versus the “long” signal gives excellent separation of the neutron induced events from the gamma-ray induced events. Pulses with large “short” amplitudes and small “long” amplitudes are due to gamma rays. Pulses with small “short” amplitudes and large “long” amplitudes are due to neutron capture in the ⁶Li in the scintillator. A region of interest that includes only neutron events can be defined for the two-dimensional array. Events that fall within the neutron region have their “total” amplitude recorded in a separate one-dimensional histogram. Likewise, events in the gamma region have their “total” amplitude recorded in a separate histogram. In this manner, the pulse height spectra for neutrons and gamma rays can be obtained separately from one detector.

### Results

An example of a two-dimensional histogram of short-gate pulse heights versus long-gate pulse heights is shown in FIG. 2 for a ¹³⁷Cs source irradiating crystal F. No polyethylene moderator was near the scintillator so background thermal neutron pulses were minimized. Two regions of interest are shown in the figure, Regions A and B. The one to the left, Region A, was constructed to include most of the gamma-ray events while minimizing neutron events and events caused by dark current in the photomultiplier tube (nearly vertical distribution to far left). The region in the lower right, Region B, is the expected location of neutron events. Most of the events in FIG. 2 lie within the region defined for gamma rays although at small pulse heights it is difficult to distinguish gamma-ray events from dark current events.

More particularly, FIG. 2 illustrates a two-dimensional histogram of short-interval pulse heights versus long-interval pulse heights for ¹³⁷Cs source with no moderator near the scintillator. Most events occur in the gamma region (Region A, on the left). Photopeak for 662-keV gamma rays appears near X, Y channels (20, 95).

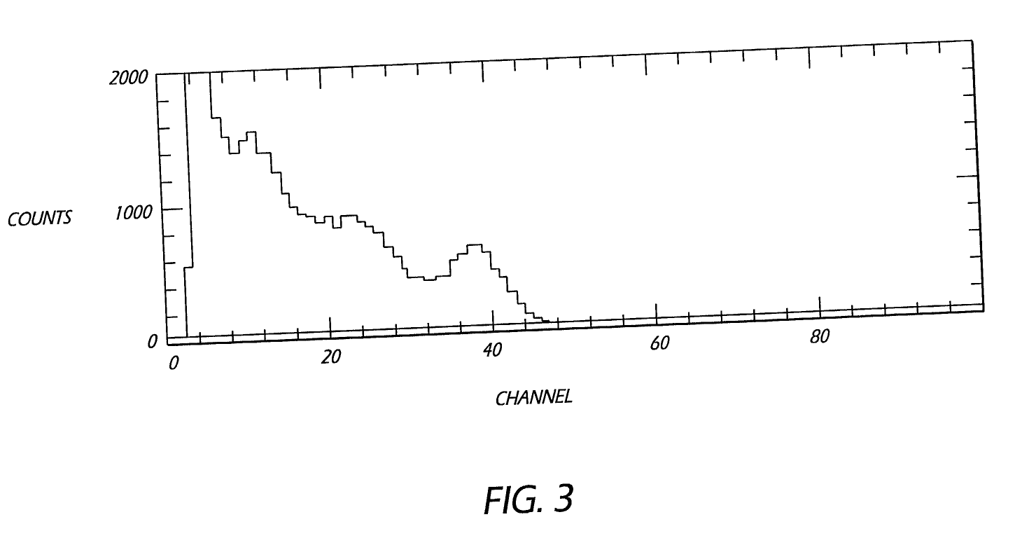

For all the events within the gamma region, a new histogram was constructed based on the pulse height generated by the “total” gate. This histogram is shown in FIG. 3. The background taken without the source was negligible and has not been subtracted from the data shown. Because the crystal is quite small, the intensity of the photopeak at 662 keV from ¹³⁷CS is quite small. Most of the pulses are due to Compton scattering. However, the 662-keV peak is clearly visible and has a FWHM of about 16%.

More particularly, FIG. 3 illustrates a one-dimensional histogram of total-interval pulse heights for events falling into the left region (Region A) in FIG. 2. Photopeak for 662-keV gamma rays from ¹³⁷Cs appears at about channel 37.

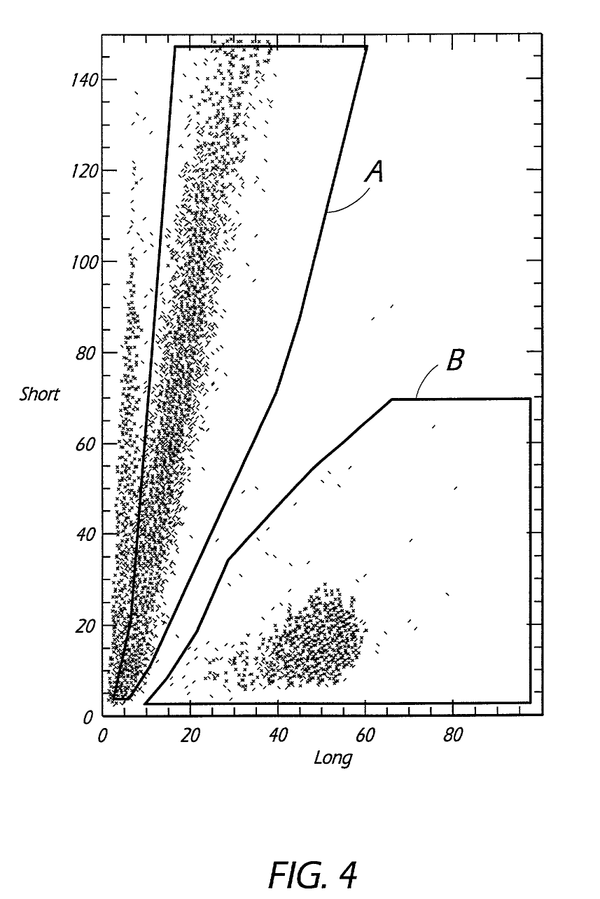

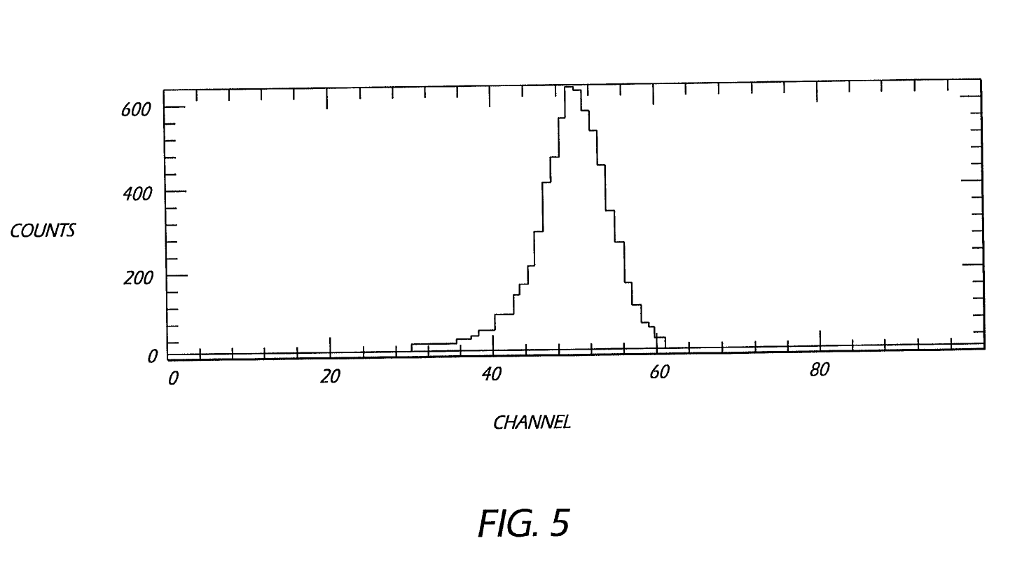

The same crystal surrounded with polyethylene was also irradiated with a PuBe neutron source. The two-dimensional spectrum is shown in FIG. 4. The number of counts in the neutron region is greatly increased and cluster near X, Y channel (49, 15), Although the PuBe source has many gamma-ray events, they are clearly distinguished from the neutron events. The one-dimensional histogram based on the pulse heights from the “total” gate for events within the neutron region is shown in FIG. 5. Again the background without the source was negligible and has not been subtracted. The distribution of thermal neutron events in FIG. 5 has a FWHM of about 17%. There is a small tail toward lower pulse heights in FIG. 5 that is thought to be due to fast neutron elastic scattering on Li isotopes in the crystal.

More particularly, FIG. 4 illustrates a two-dimensional histogram of short-interval pulse heights versus long-interval pulse heights for PuBe source with polyethylene moderator near the scintillator. Note the events occurring in the neutron region (Region B, in the lower right). The thermal neutron peak appears near X, Y channels (49, 15).

More particularly, FIG. 5 illustrates a one-dimensional histogram of total-interval pulse heights for events falling into lower-right region in FIG. 4. Thermal neutron peak appears at about channel 50.

Pulse height spectra were obtained for each of the crystals listed in Table 1. The pulse height amplitude of the neutron peak was used as a measure of the light output. This is not a precise definition of light output because the pulse height is dependent on the particular gate times chosen for the QDCs. The comparisons of light output must be viewed with caution because of the variations in crystal shapes and polishing. The light output as defined here is listed in Table 4 and compared with the Ce content.

In general, the LiBaF₃ samples doped with both Ce and Rb showed the highest pulse height. The sample doped with Ce and K was almost as good. The sample with only Ce doping gave about half the pulse height of the co-doped samples and had about half the Ce content. The undoped crystal gave about 1/10 the pulse height of the best Ce and Rb doped crystal, but this is partly related to the long fluorescence lifetime which puts most of the light outside of the 1.4 μs “total” gate. Future work should vary the gate times to minimize the resolution and maximize the neutron/gamma-ray discrimination.

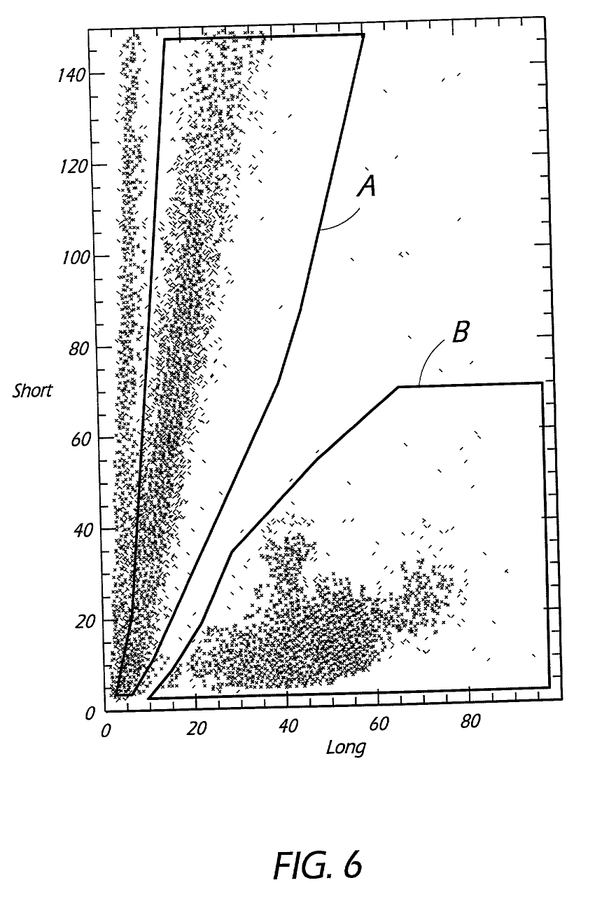

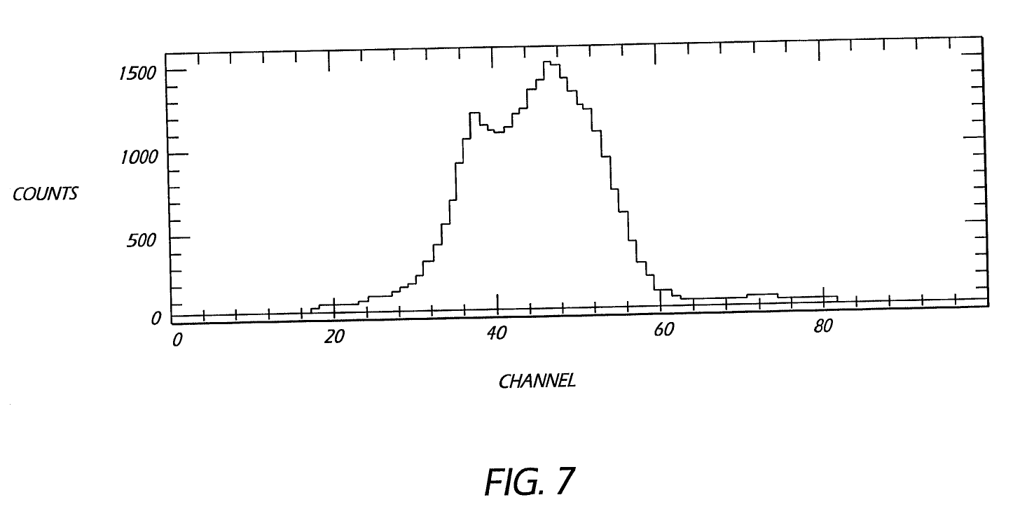

Background spectra taken over several days show a double-humped distribution in the two-dimensional histogram. An example of the background spectrum obtained for crystal F is shown in FIG. 6. The data were obtained with no moderator near the scintillator and a cadmium shield around the scintillator and photomultiplier tube (PMT) to eliminate thermal neutrons. The events in the neutron region are attributed to alpha particles from Ra impurities in the Ba. The one-dimensional spectrum for the neutron region is shown in FIG. 7. Such events were also seen by the Delft group. For applications requiring extremely low backgrounds, it will be necessary to purify the starting Ba compounds before growing the crystals.

More particularly, FIG. 6 illustrates a two-dimensional histogram of short-interval pulse heights versus long-interval pulse heights for a long background count with no polyethylene moderator near LiBaF₃ scintillator F. Events in the neutron region are mostly due to alpha particles from decay of Ra and its daughter activities.

More particularly, FIG. 7 illustrates a one-dimensional histogram of total-interval pulse heights for events falling in the lower right region defined in FIG. 6. Pulses in the region from channel 30-65 are thought to be due to alpha particles.

Preliminary results with the PuBe source with no moderator around the detector show enhanced counts over background in the region from the thermal peak up to 2-MeV neutron energy. Although the efficiency for measuring the spectrum of fast neutrons is quite low for this detector, these preliminary results allow us to predict that a future scintillator made with enriched ⁶Li would easily distinguish thermal neutrons from fast neutrons.

### Conclusion

The results we have obtained to date confirm the remarkable ability of LiBaF₃ to distinguish neutron radiation from gamma-ray radiation as reported by the Delft group. The data acquisition system developed here uses the presence of both the core valence and Ce⁺³ luminescence to identify gamma-ray events and the absence of these two luminescence components to identify neutron events. This system allows simultaneous acquisition of a neutron pulse height spectrum and a gamma-ray pulse height spectrum from a single scintillator with negligible interference between the two types of radiation.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

TABLE 1
Description of LiBaF₃ Samples Studied in This Work

| Sample | | | | |
|---|---|---|---|---|
| ID | Source | Doping | | Physical Shape |
| A | AC Mat. | Ce + Rb | Cyl.: | 1.3-cm dia. × 1.1 ± 0.2-cm |
| | | | | high |
| B | AC Mat. | Ce | Disk: | 1.7-cm dia. × 0.4-cm high |
| C | AC Mat. | pure | Disk: | 2.1-cm dia. × 0.4-cm high |
| D | Delft #6 | Ce + Rb | Shard: | L ^{˜}1.3 cm, W ^{˜}0.6 cm. H ^{˜}0.2 |
| | | | | cm |
| E | Delft #5 | Ce + K | Cyl.: | 1.7-mm dia. × 1.0 ± 0.6-cm |
| | | | | high |
| F | AC Mat. | Ce + Rb | Disk: | 1.3-cm dia. × 0.6-cm high |

TABLE 2
Composition of LiBaF₃ samples given as mol %

| Sample | C (AC Mat.) | B (AC Mat.) | E (Delft) |
|---|---|---|---|
| Doping | none | Ce | Ce + K |
| Mg | 0.115 ± 0.006 | 0.0025 ± 0.0003 | 0.041 ± 0.017 |
| Ti | | | |
| V | <0.02 | <0.002 | 0.0004 ± 0.0000 |
| Fe | <0.25 | 0.0004 ± 0.0000 | 0.202 ± 0.057 |
| Rb | 0.0038 ± 0.0002 | 0.0002 ± 0.0000 | 0.0003 ± 0.0001 |
| Sr | 0.292 ± 0.032 | 0.0175 ± 0.0017 | 0.0007 ± 0.0001 |
| Y | <0.009 | 0.0063 ± 0.0004 | 0.0016 ± 0.0003 |
| Mo | 0.074 ± 0.010 | | 0.0008 ± 0.0001 |
| Ba | 102.8 ± 10.2 | 99.5 ± 5.5 | 103.6 ± 11.4 |
| La | <0.002 | 0.0001 ± 0.0000 | <0.0001 |
| Ce | | 0.0023 ± 0.0001 | 0.0070 ± 0.0015 |
| Nd | | <0.0007 | |
| Pb | 0.0029 ± 0.0001 | <0.0001 | 0.0095 ± 0.0040 |
| Sample | A (AC Mat.) | D (Delft) | F (AC Mat.) |
| Doping | Ce + Rb | Ce + Rb | Ce + Rb |
| Mg | 0.0231 ± 0.0014 | 0.0076 ± 0.0002 | 0.0050 ± 0.0004 |
| Ti | <0.16 | <0.046 | <0.0029 |
| V | <0.027 | <0.0028 | 0.0020 ± 0.0001 |
| Fe | 0.0115 ± 0.0001 | | 0.0018 ± 0.0000 |
| Rb | 0.416 ± 0.031 | 0.425 ± 0.029 | 0.507 ± 0.021 |
| Sr | 0.328 ± 0.052 | 0.0049 ± 0.0006 | 0.334 ± 0.020 |
| Y | 0.0133 ± 0.0012 | 0.0053 ± 0.0003 | 0.0081 ± 0.0003 |
| Mo | <0.021 | <0.01 | |
| Ba | 103. ± 16. | 99.1 ± 11.2 | 101.1 ± 11.1 |
| La | 0.0007 ± 0.0001 | <0.0002 | 0.0009 ± 0.0002 |
| Ce | 0.0043 ± 0.0002 | 0.0044 ± 0.0002 | 0.0074 ± 0.0004 |
| Nd | | | 0.0013 ± 0.0001 |
| Pb | <0.0007 | 0.0005 ± 0.0001 | 0.0008 ± 0.0001 |

TABLE 3
Scintillation properties of LiBaF₃ based crystals measured at Delft U.

| | | | Pulse | Actual |
|---|---|---|---|---|
| | | | shaping | Conc. |
| | | Yield | time | Ce⁺³ |
| Crystal | Lifetimes | (photons/MeV) | (μs) | (mol %) |
| LiBaF₃ pure | CV, 12.1 μs | 970-1190 | 0.5 | |
| LiBaF₃:Ce⁺³ | CV, 57 ns, 13 μs | 1320 | 0.5 | 0.09 |
| LiBaF₃:Ce⁺³,K⁺¹ | CV, 34 ns, 2.1 μs | 1880 | 0.5 | 0.31 |
| LiBaF₃:Ce⁺³,Rb⁺¹ | CV, 34 ns, 2.4 μs | 2130 | 1.0 | 0.20 |

TABLE 4
Light output (pulse height of neutron peak) for various LiBaF₃ samples
compared to measured Ce content. All pulse heights have been
normalized to a PMT high voltage of −1800 V.

| Sample ID | Co-dopant | Ce (mol %) | Pulse Height (Ch. No.) |
|---|---|---|---|
| C (AC Mat.) | pure | not observed | 5.7 |
| B (AC Mat.) | none | 0.0023 ± 0.0001 | 21.0 |
| E (Delft) | K | 0.0070 ± 0.0015 | 45.7 |
| A (AC Mat.) | Rb | 0.0043 ± 0.0002 | 40.2 |
| F (AC Mat.) | Rb | 0.0074 ± 0.0004 | 50.5 |
| D (Delft) | Rb | 0.0044 ± 0.0002 | 53.9 |

1. A radiation detection and discrimination device, comprising:
a radiation sensor comprising a LiBaF₃ scintillator configured to simultaneously detect presence of a first type of radiation and a second type of radiation and generate an output signal for each type of detected radiation; and
signal processing circuitry communicating with the sensor including data analysis circuitry and memory, the signal processing circuitry operative to receive at least one output signal from the sensor;
wherein the memory is operative to store at least one predetermined indicia characterizing membership of an output signal within a group comprising a unique type of radiation, and wherein the data analysis circuitry compares the output signal with the at least one predetermined indicia to determine membership of the output signal within one group of a plurality of unique groups each comprising a unique type of radiation including the first type of radiation and the second type of radiation.

2. The device of claim 1 wherein the signal processing circuitry analyzes a pulse shape of the output signal comprising pulse amplitude versus time, wherein the at least one indicia comprises a histogram of pulse amplitude versus time, and wherein the data analysis circuitry compares the pulse shape of the output signal with the histogram to determine membership of the output signal within one group of a plurality of unique groups.

3. The device of claim 1 wherein the radiation sensor further comprises a photomultiplier (PM) tube communicating with the LiBaF₃ scintillator.

4. The device of claim 3 wherein the radiation sensor further comprises a thin, light-tight window configured to allow alpha particles to reach the scintillator.

5. The device of claim 1 further comprising a user interface communicating with the signal processing circuitry and operative to display detected presence of at least one of the first type of radiation and the second type of radiation.

6. The device of claim 5 wherein the user interface comprises a first display meter for displaying detected presence of the first type of radiation and a second display meter for displaying detected presence of the second type of radiation.

7. The device of claim 6 wherein the LiBaF₃ scintillator is configured to detect presence of a third type of radiation, wherein the plurality of unique groups each comprise a unique type of radiation including a third type of radiation, and wherein the user interface comprises a third display meter for displaying detected presence of the third type of radiation.

8. The device of claim 6 wherein the first type of radiation comprises alpha radiation and the second type of radiation comprises beta/gamma-ray radiation.

9. The device of claim 7 wherein the first type of radiation comprises thermal neutron radiation, the second type of radiation comprises fast neutron radiation, and the third type of radiation comprises beta/gamma-ray radiation.

10. The device of claim 1 wherein the signal processing circuitry is provided by electronics within a hand-held housing, and wherein the radiation sensor is remotely coupled with the housing via a flexible electrical cable.

11. A radiation survey instrument, comprising:
a scintillation sensor of a single material capable of simultaneously detecting and discriminating a plurality of unique types of radiation and generating an output signal from a detected type of radiation; and
signal processing circuitry communicating with the sensor and operative to receive the generated output signal from the scintillation sensor and compare the output signal with a predetermined histogram of pulse amplitude versus time;
wherein the signal processing circuitry compares the pulse shape of the output signal with the histogram to determine membership of the output signal within an identified type of radiation from the plurality of unique types of radiation.

12. The radiation survey instrument of claim 1 1 wherein the scintillation sensor comprises a LiBaF₃ scintillator configured to detect a plurality of unique types of radiation.

13. The radiation survey instrument of claim 12 further comprising a photomultiplier (PM) tube communicating with the LiBaF₃ scintillator.

14. The radiation survey instrument of claim 11 further comprising a portable housing configured to carry the signal processing circuitry.

15. The radiation survey instrument of claim 14 further comprising an electrical cable coupling the scintillation sensor with the housing to enable positioning of the sensor relative to the housing while conducting a radiation survey.

16. The radiation survey instrument of claim 15 wherein the signal processing circuitry comprises data analysis circuitry configured to analyze a pulse shape of the output signal and compare the pulse shape with at least one predetermined histogram.

17. The radiation survey instrument of claim 11 wherein the scintillation sensor comprises a window disposed in front of the single material and operative to enable alpha particles to reach the single material.

18. A method of simultaneously measuring for the presence of at least two unique types of radiation, comprising:
in a radiation detector, detecting the presence of one type of at least two types of radiation;
in response to detecting the one type of radiation, producing an output signal having a pulse shape comprising output pulse amplitude versus time;
storing a first digital data set representative of a first type of radiation and a second digital data set representative of a second type of radiation; and
comparing the output signal pulse shape of the one type of detected radiation with the first digital data set and the second digital data set to determine identification of the output signal pulse shape as either a first type of radiation or a second type of radiation.

19. The method of claim 18 wherein the radiation detector comprises a LiBaF₃ scintillator configured to detect presence of a first type of radiation and a second type of radiation and generate corresponding output signals for each type of detected radiation.

20. The method of claim 19 wherein the first type of radiation comprises alpha radiation and the second type of radiation comprises beta/gamma-ray radiation.

21. The method of claim 18 wherein the scintillator is further configured to detect presence of a third type of radiation, and wherein the first type of radiation comprises thermal neutron radiation, the second type of radiation comprises fast neutron radiation, and the third type of radiation comprises beta/gamma-ray radiation.

22. The method of claim 18 wherein the first digital data set comprises a first reference pulse shape digital data set representative of a shape of a detection signal for the first type of radiation, and the second digital data set comprises a second reference pulse shape digital data set representative of a shape of a detection signal for the second type of radiation.
